(19) United States
(12) Patent Application Publication
(10) Pub. No.: US 2022/0402247 A1
(43) Pub. Date: Dec. 22, 2022

(54) Self-Mending Cutting Deck

(71) Applicant: I-Crafter LLC, Chino, CA (US)

(72) Inventor: Xinwang YE, Longwo Town (CN)

(73) Assignee: I-Crafter LLC, Chino, CA (US)

(21) Appl. No.: 17/486,026

(22) Filed: Sep. 27, 2021

(30) Foreign Application Priority Data
Jun. 21, 2021 (CN) 202121378889.9

(51) Int. Cl. B32B 27/08; B32B 27/40; B32B 27/36; B32B 7/12

(52) U.S. Cl. CPC B32B 27/08; B32B 27/40; B32B 27/365; B32B 7/12; B32B 2307/536; B32B 2250/03; B32B 2250/24; B32B 2250/40; B32B 2307/762

(57) ABSTRACT

Present invention teaches a self-mending cutting deck made up of a PC center board, sandwiched by a TPU upper and a TPU lower board, glued together using TPU glue. The TPU material has good resilience to the cuts made and will greatly reduce the cut marks, tiny grooves that are seen on other cutting decks. The specific hardness level of 90 degrees chosen provides long useful life without the warping problem faced by other existing products.

### CLAIM FOR FOREIGN PRIORITY

The present invention claims the earlier filing date of foreign filing in China, date Jun. 21, 2021, having application number 202121378889.9.

### FIELD AND BACKGROUND OF THE INVENTION

Currently available cutting decks are around for quite a whole. They are used in conjunction with a cutting die (framelits or thinlits) on a rolling-press machine to produce the desired crafting effect based upon the selected shapes or patterns.

Due to the pressing power and the cuts made from repeated use, many existing cutting decks will have cut marks, tiny grooves, and uneven/irregular warping. As the surface becomes warped, and scattered with cut marks, such cutting decks become difficult to use and the results are oftentimes disappointing.

The cutting deck of present invention uses TPU board and TPU glue, with proper hardness rating with the inherent resilience to resist the cut marks, and, even if there is cut marks, the TPU material has the inherent ability to restore the original shape, i.e., self-mending functionality.

Based upon the inventor's experience, the TPU material's hardness rating, as measured in Shore D Hardness Scale, is preferred to be 90, to provide the best resilience for regular using.

A cutting deck made pursuant to the teaching herein has the self-mending feature to reduce cut marks, or tiny grooves that are often the result of repeated uses; also, the cutting deck made pursuant to the teaching herein will resist warping, prolonging the useful life of such a cutting deck relative to many of the existing products.

### SUMMARY OF THE INVENTION

The cutting deck of present application has a polycarbonate (PC) center board. The cutting deck further has a TPU upper board and a TPU lower board that are attached to the two sides of the PC center boards.

The PC center board's two sides are applied with TPU glue of substantially 1 mm thickness, gluing the upper and lower boards to the two sides of the PC center board.

The preferred embodiment of the present invention uses a TPU board, both upper and lower boards, with hardness rating at 90 degrees.

The finished product will have a better use quality due to TPU materials' resilient feature to self-mend. The surface of the cutting deck will remain smooth and even, without warping and will provide a longer-lasting useful work surface for the intended usage, superior to other existing products.

### DESCRIPTION OF THE DRAWINGS

The accompanying drawings exemplify the preferred embodiments of the invention. Together with the description, serve to explain the principles of the invention.

A brief description of the drawings is as follows:

FIG. 1 is the integrated perspective view of the self-mending cutting deck of present application.

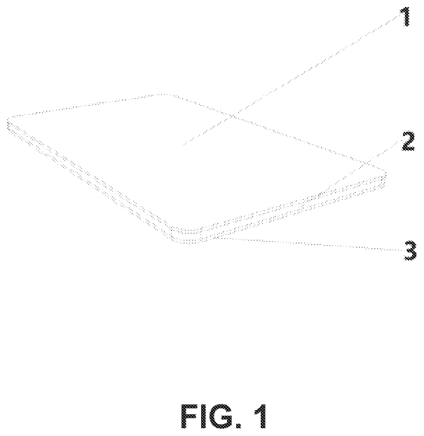

FIG. 2 is the blow-up view of the parts of the present invention.

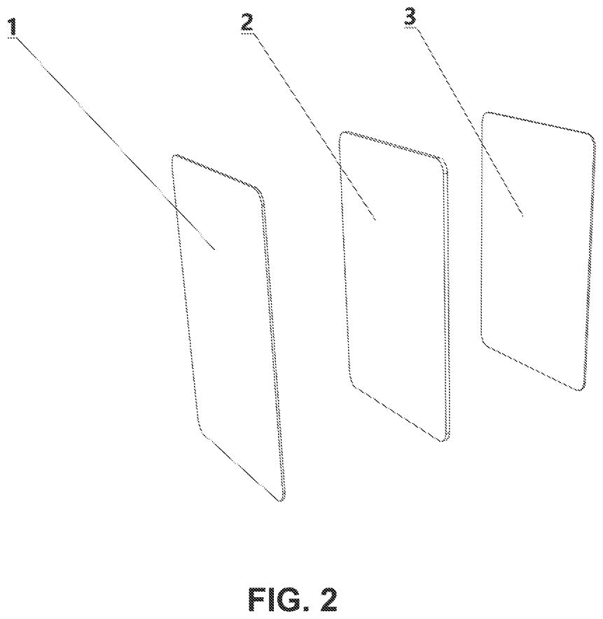

### DETAILED DESCRIPTION OF THE PREFERRED EMBODIMENT

The present application relates to a cutting deck having a construction, with specifical materials, to provide a self-mending feature.

The cutting deck has a TPU upper board 1, a polycarbonate (PC) center board 2, and a TPU lower board 3.

The PC center board 2's two sides are applied with TPU glue of substantially 1 mm thickness, gluing the upper board 1 and lower board 3 to the two sides of the PC center board 2.

The preferred embodiment of the present invention uses a TPU board, both upper and lower boards, a Shore D Hardness value of 90.

The finished product will have a better use quality due to TPU materials' resilient feature to self-mend and will provide a longer-lasting useful work surface for the cutting deck, superior to other existing products.

The teachings presented herein are the preferred and exemplary embodiments of the invention as disclosed. Further modifications and improvements will be readily apparent to those skilled in the art. The scope and spirit of the present invention is not to be limited the embodiments herein, but is to be understood in the broadest sense allowed by law commensurate with the disclosure of this application.

1. A self-mending cutting deck, comprising,
a TPU upper board;
a polycarbonate (PC) center board; and
a TPU lower board wherein
the PC center board's two sides are applied with TPU glue of substantially 1 mm thickness, serving to glue the upper and lower boards to the two sides of the PC center board.

2. The self-mending cutting deck of claim 1 wherein the preferred TPU boards' Shore D Hardness value is 90.
